(19) United States
(12) Patent Application Publication
(10) Pub. No.: US 2002/0073178 A1
(43) Pub. Date: Jun. 13, 2002

(54) Central programming system with distributed playback devices

(76) Inventor: Reza Jalili, New York, NY (US)

Correspondence Address: OSTROLENK FABER GERB & SOFFEN, 1180 AVENUE OF THE AMERICAS, NEW YORK, NY, 100368403

(21) Appl. No.: 09/910,192

(22) Filed: Jul. 20, 2001

Related U.S. Application Data
(60) Provisional application No. 60/219,764, filed on Jul. 20, 2000.

(51) Int. Cl. G06F 15/16

(52) U.S. Cl. 709/219; 709/231

(57) ABSTRACT

Disclosed is a digital publishing system that receives input from distributed clients cooperatively contributing to a digital magazine for electronic delivery to electronic playback devices such as Internet connected TVs, radios, CD players, and other devices. The disclosed system and method provide shared access to a TV screen and other playback devices' resources. For example, multiple users of the system can have access to various areas of a screen at various times.

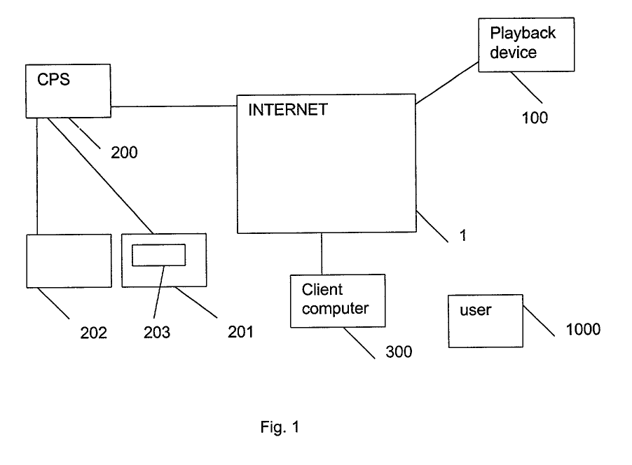

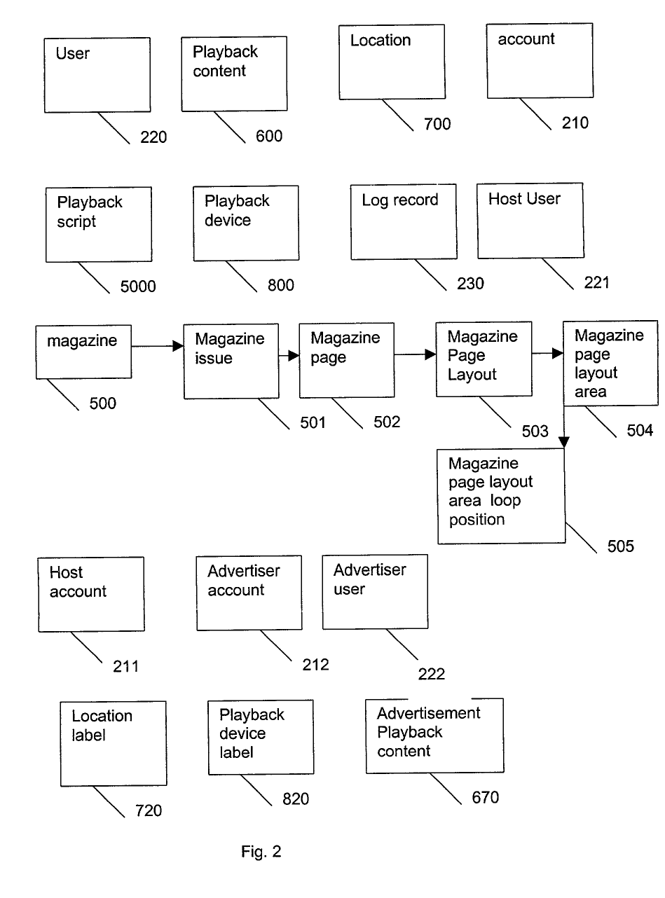

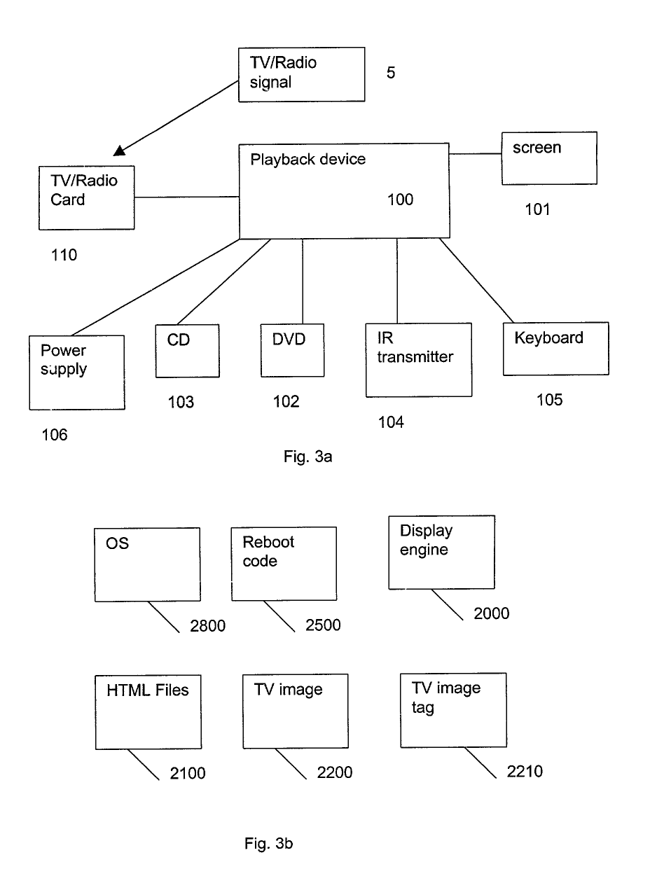

### RELATED APPLICATIONS

This application is based on and claims priority to U.S. Provisional Patent Application Nos. 60/219,764, filed Jul. 20, 2000.

### FIELD OF INVENTION

The invention is directed generally to the field of digital publishing and specifically to electronic playback devices such as TVs, CD players, Radios.

### OVERVIEW

The playback devices (adaptors) (100) are made up of a computer, a display, optional speakers, optional infra-red transmitters, and means for connecting to the internet, whether that is a modem, DSL, T1, wireless or some other means.

The central program server (CPS) (200) accepts connections from clients (300). A user (1000) uses a client (300) to access the central program server using a standard userid/password combination. A user (220) is a logical entity that is recognized by the central program server (CPS) and has certain attributes such as a role, permissions, and quotas.

The CPS stores playback content (600) for all playback devices located physically in remote locations around the world. The CPS creates a playback script (5000) for each playback device and delivers said playback script to said each playback device. The CPS can create a playback script for each playback device either in advance of or in response to a request by a playback device.

### Playback Device

### Features

The playback device is a hybrid analog/digital device. The Sidecast TV™ device, for example, can play digital playback content (aka Sidecast™) from the CPS while also showing live broadcast TV received through a cable-TV cable or an aerial antenna. A SidecastCD™ device can play digital playback content (aka Sidecast™) from the CPS while also playing an inserted music CD-ROM. Similarly, a SidecastDVD™ player with a movie DVD.

Hardware Features

Modem to connect to the Internet using a dial-up connection from a national ISP at a cost of about $19.95 or down to $8.95 in bulk.

Disk drive of 2 Gigabytes minimum to store the operating system and playback content.

CD-ROM drive or ZIP drive to allow for input of data at higher bandwidth than modem and for overriding action of retrieving playback content from Internet. For a SidecastCD™ device, a CD-ROM is also used to playback music CDs.

CPU, memory (64MB), optional sound card, and video chip.

TV card (110) that can tune in television signals and interface with the video display sub-system. (WinTV® is a brand that works well). This is used in the SidecastTV™ device. (optional)

A display screen (101). (optional, but necessary most of the time)

A DVD player (102). (optional)

An infra-red transmitter or IR port (104) to transmit data via an IR link. (optional)

Optional keyboard and mouse for manual set-up, maintenance, and overriding settings. (105)

Power supply that can be shutdown under software control. (optional) (106)

Software Features

Reboot (2500) the operating system. This, when done periodically, helps to keep the system fresh from memory leaks and other problems associated with a buggy operating system.

Windows (®) Operating System (2800) is used because of the vast software tools and applications available.

A Display Engine (2000) which can show:

HTML files (2100) along with all related file types such as Flash, Shockwave, GIF, JPEG, MPEG, text, scrolling text, and so on.

TV image (2200) that it receives by interfacing with the TV card. The TV image (2200) can be shown in any rectangular area (masked by any other shape to achieve special effects) anywhere on the screen.

The display engine can show just the HTML file or the HTML file and the TV image.

The TV image is controlled by a special tag (2210) in the HTML file. Optionally the specification can be given in a file with the same name as the HTML file, but with a “.TV” extension instead of a “.HTML” or “.HTM” extension.

The TV specification gives:

the X and Y coordinates of the topleft corner of the TV image as a percentage of the total screen dimensions or in pixel units and similarly gives the width and height of the TV image.

The channel to tune the TV card.

Any other accessible parameters of the TV card, such as saturation, hue, tint, volume, and so on.

A sample specification would be:

<TVSPEC T=0 L=0 W=480 H=450>

### Accessing the CPS and Playback

A playback device accesses the CPS as a user with a userid/password combination and an identifier called the AdaptorId.

A playback device retrieves a compressed archive file (a .ZIP file) from the CPS. This file is uncompressed and its contents are stored on the local disk.

Playback content retrieval is scheduled to occur periodically and/or when the playback device is booted or turned on (for the case where the playback device is manufactured with a built-in or instant-on operating system).

When the playback device starts, it runs the display engine software. The display engine automatically reads a file called page1.html (this can be overridden by a command-line option). The initial page1.html file is created at start-up by copying a pre-installed file called splashScreen.html to page1.html. SplashScreen.html shows a start-up screen on the display and periodically refreshes using JavaScript. The result is that when a content retrieval operation updates page1.html, the most recently created page1.html file replaces the splash screen.

Other start-up operations include the logging of the start time in a log file.

When content is retrieved from the CPS, the log file can be sent back to the CPS.

When content is retrieved from the CPS, the display engine software and other system software for the playback device can also be retrieved and installed. This allows for remote maintenance and updates.

### Programming the CPS

The Central Programming Server is a web-server (201) with a database (202) and code (203) to:

Create an account (210)

Create a user (220)

Create a magazine (500)

Create a magazine issue (501)

Create a magazine page (502)

Create a magazine page layout (503)

Create a magazine page layout area (504)

Create a magazine page layout area loop-position (505)

Receive and store playback content (600)

Create a location record (700)

Create an adaptor (playback device) record (800)

Create a log record (230)

Create playback instructions (5000) (e.g. HTML with JavaScript) for a playback device

Associate playback content with a particular magazine page layout area loop-position, optionally with a time-dependency so that only at a particular time of day or date or day of the year, the given playback content is actually played.

The CPS is programmed for the following concepts:

That a set of playback devices are installed in many physical locations.

That the playback devices can be symbolically labeled and later retreived individually or as groups, based on attributes. For example, a set of playback devices can be labeled with “Front Window” and others with “Cashier Area” and then programming can be applied to the set of all “Front Window” adaptors.

That physical locations where playback devices (aka “adaptors”) are installed are owned by an owner, called a Host account (211).

That the locations can be labeled in the same way as the playback devices.

That the playback devices have hardware limitations and resources, such as the screen size and resolution of the physical screen connected to a given playback device, or that a playback device has IR capability.

That the CPS administrators are super users and can access and change all data.

That users belonging to a Host account (211) if given the role of editor or super user, can create magazine issues, manage the pages, layout, and content of said magazine issues and also control the distribution of said magazine issues to the playback devices. Playback devices to receive a magazine can be specified by zip-code, by location labels (720), by playback device label (820), or some other search criteria for playback devices.

That there are entities that would like to provide content on a fee basis to be shown on a set of playback devices potentially across magazines and across Hosts. An Advertiser account (212) is for these entities.

That users belonging to an Advertiser account (212) can load advertisements into the CPS that will be treated by the CPS as playback content, but also recognized as something for which a fee should be charged, i.e. an advertisement placement.

That screen-time on playback devices as well as IR transmission time can be sold to Advertisers. Advertisers have accounts for billing and e-commerce transactions of a B-to-B nature will be conducted between the CPS owning entity (Ch1 Communications Inc., for example) and the Advertising entity.

That advertising, if not all playback content, will be measured in duration in some units, for example, seconds or 7.5-second units, and that fees will be charged for the use of screen-space and for the use of screen-time. The fees will be calculated based on a formula taking into consideration the size of the magazine page layout area and the duration of the magazine page layout area loop-position as well as special specifications, such as time-of-day, day-of-month, day-of-year, and so on.

That each Advertiser user (222) can only view the advertisement playback content (670) owned by that advertiser.

That a Host user (221) can designate any number of magazine page layout area loop-positions to be available for advertisers.

That a Host user (221) can designate any number of magazine page layout area loop-positions to be available to another Host user by specifying that user explicitly, by label, by account, by predefined category of users, where the user members of that category of users can be specified by listing explicitly the users, by user labels, by accounts, and so on.

That accounts and users can have associated labels in order that groups of like or unlike accounts and users can be created.

That playback devices will periodically access the CPS using a userid/password and adaptorId to identify themselves and request the latest playback content.

That a magazine page layout area can be filled with content that is represented or specified using a data file, such as an image, a video, an audio file, or text.

That a magazine page layout area can be filled with auto-generated content such as time, temperature reading, TV signal, AM/FM radio signal, or other sensor-generated or playback device-generated information at the time of playback by the playback device.

That a magazine page layout area can be automatically filled by the CPS using random or otherwise loosely specified content from a playback content category.

The CPS presents a set of web-pages for interaction with a user to manage accounts, users, magazines, playback content, advertising playback content, billing, viewing playback device performance, viewing schedules and show statistics of playback devices, managing groups or categories of accounts, users, playback devices, locations, and playback content. The basic grouping or categorizing mechansim is the application of a text label to the corresponding database record. Any number of labels can be applied. The corresponding records can be retrieved using an “AND” or “OR” of labels.

The CPS can create an HTML file with the appropriate JavaScipt code for playback of a magazine issue or a single page of a magazine issue, or a single layout area of a magazine page, or a single loop-position of a single layout area of a magazine page. Using a checkbox, a user can check each layout area and loop-position to be viewed. If the user has sufficient viewing privileges for a given playback content, then that playback content is show, otherwise, a place-holder image is shown.

Where the playback device has an embedded or local web server, the playback engine retrieves information locally from the local web server. The local web server retrieves content from the CPS. The local web server (WEBSERVERNUMBER) can interpret custom markup tags in the playback information and perform local actions. One example, is a playback device with a TV tuner, wherein the playback display engine retrieves a page of information to display and the local web server in addition to supplying the information to the display engine interprets specifications for the position and channel of a TV picture, tunes the TV tuner and arranges for the TV picture to be displayed, either superimposed or under the display of the display engine output.

All claimed elements are software elements, methods, and systems which coordinate the delivery, reception, interpretation, and physical interfaces of data.

### Advantages

This publishing system allows various and many content providers to provide content for a particular addressable playback device or group of playback devices, whether one or 10,000 devices, whether down the street, or around the world.

Content is categorized by each user.

Content is delivered on a timely basis efficiently and effectively using the Internet.

Content is secure on the CPS and on each playback device.

Content providers, including advertisers especially, can get a report of the times and places their content was shown.

IR data including coupons, directions, or other information can be beamed to PDA devices or other suitable receiving devices in proximity to a playback device.

Local playback devices, with the local web server architecture described or a similar one, can locally interpret and produce augmented and specific results. For example, showing the local time or the local temperature, or the live local output of an attached video camera, VCR, DVD, or other device.

### Advertisement Placement

A user of an Advertiser account can upload digital advertisement content.

### Special Considerations

The CPS is designed with the following optimizations and special considerations:

A playback content is stored only once and referenced by each magazine page layout area loop-position record that references it.

Playback content is delivered to each playback device once and is not transmitted again unless the playback content is changed since it was delivered to the playback device or the playback content is removed from the playback device.

A new magazine issue can be copied from a previous magazine issue in order to save editing time.

Pages of a magazine issue can be copied to a clipboard and pasted into a magazine issue.

Layout areas of a magazine issue can be copied to a clipboard and pasted into a magazine issue. Ideally, the magazine page layout areas should be compatible in size or the playback content should not be sensitive to magazine page layout area size.

### Exhibits

1) Diagram of Entire System

2) Diagram of CPS components

3) Diagram of SidecastTV

4) Printout of Database Schema

5) Printout of sample playback device script with TV tag.

6) Printout of PHP code modules.

7) Screen shots of Sidecast Engine (Web-site)

8) Printout of the “cookbook”

### Playback Device

The Playback Device is a display engine. It functions as a means for showing multimedia content through a browser. It is capable of showing and looping multimedia content at specific times, including, but not limited to, daily specific periods. It also logs the start and stop times of the multimedia loop. The Playback Device is able to accept CDs, zip drives and can load information from the Internet or local disks. The current embodiment of the System utilizes a modem and other similar means of communication (?). Admittedly, there are security issues that are unavoidable but which are best resolved with the use of the modem.

The display engine consists of two components: the television area and the Sidecast area. The areas are adjacent to each other. This split-screen television contains a layout interpreter. The layout interpreter is capable of interpreting a layout specification. The layout specification is an HTML web-page. The web-page contains at least one tag. The layout interpreter interprets the tag. In addition, the layout interpreter also executes the following tasks: reading a layout specification file, positioning a TV area, sizing a TV area and setting the channel or other properties of the TV area. Setting the channel is a determination to be made by the host of the device and is subject to change as often as desired.

The display engine is also a means for transmitting and receiving IR data and is capable of coordinating IR data with multimedia shown on the screen.

### Publishing System

The Publishing System is an online publishing system that consists of four (4) components: a client computer, a server computer, a second client computer, and a database. The Publishing System creates a plurality of magazine records and magazine page records in said database. The magazine records contain different versions and combinations of screen layouts. The user may edit or view the layouts acting in the capacity of host, manager, editor, etc. The layouts contain three areas of content. For any given area of content, the user may elect to choose content from the content gallery. While choosing the content gallery, user refers to a thumbnail picture of the layout. The user can choose and control the timing of the content selection. The user can create at least one layout area where playback is automatic. The system has the potential to store content.

The system can create an HTML file with embodied specifications for TV operation. The system has the means for creating HTML instructions representing a page. The system may also emit and receive IR signals that may be stored in playback device for delivery to said publishing system at either a later time, a pre-defined point in time or periodically.

### Online Advertising Booking System

The Online Advertising Booking System is a system which allows the user to view available advertising slots and select a set of advertising slots. The user may select an advertising slot after completing a search based on severable variables such as criteria, demographics, price of ads, duration of continuous ad slots, and location of screens. Alternatively, the user may view a list of screens and subsequently select the slots. The user may also select the time for the playing of the ad and select the frequency of the playing of the ads. The System creates a report of the played ads and delivers the ads to playback devices.

The user may pay for the ad by either entering a credit card number or using a previously established account number.

[image]

[image]

[image]

[image]

[image]

[image]

[image]

[image]

[image]

I claim:

1) An digital publishing slot booking system comprising means for
a) Viewing available slots
b) Selecting a set of available slots using a plurality of criteria
(1) Price of slot
(2) Duration of contiguous slots
(3) Location of playback device
(4) Owner of playback device
(5) Capabilities of playback device
(6) start time or event and
(7) end time or event.
(8) Frequency of playback
(9) Date of playback
(10) Day of playback
c) Selecting a plurality of selected playback devices
d) Selecting a plurality of selected slots for each said selected playback device
e) Arranging for payment for said selected slots
f) Associating playback content with each said selected slot
g) Creating a report of the slots delivered to each said selected playback device
h) Creating a report of the slots played by each said selected playback device
i) Delivering said playback content to each said selected playback device

2) Playback device with means for receiving a plurality of playback data and a plurality of playback instructions, wherein said playback device has means for
a) interpreting said playback instructions,
b) rendering playback data

3) A playback device as in claim 2 wherein said means for rendering playback data is a means for displaying visual data

4) A playback device as in claim 2 wherein said means for rendering playback data is a means for producing audio

5) A playback device as in claim 2 wherein said means for rendering playback data is a means for producing radio frequency transmissions

6) A playback device as in claim 2 wherein said means for rendering playback data is a means for producing infra-red transmissions

7) A playback device as in claim 2 with means for receiving and displaying a TV signal

8) A playback device as in claim 2 with means for receiving and playing a radio signal

9) A playback device as in claim 2 with means for receiving and displaying a video signal

10) A playback device as in claim 2 with means for receiving sensor data

11) A playback device as in claim 3 further with means to position visual data on a screen using information from said playback instructions

12) A playback device as in claim 2 with means of a first rendering of playback data and a second rendering of playback data

13) A playback device as in claim 2 with means for controlling a second device attached to playback device.

14) A playback device as in claim 13 wherein said second device is a TV tuner.

15) A playback device as in claim 13 wherein said second device is a broadcast media player.

16) A playback device as in claim 13 wherein said second device is a telephony device

17) A playback device as in claim 13 wherein said second device is a recorded medium playback system (CD player, DVD)

18) A playback device with storage and means for delivery of data to a server computer, at a predetermined time, upon an event trigger, or periodically.

19) An electronic online publishing system comprising
a) A first client computer
b) A server computer
c) A second client computer
d) A database
e) Means for creating a plurality of magazine records in said database
f) Means for creating a plurality of magazine page records associated with a said magazine record in said database
g) Means for creating a layout specification with a plurality of layout areas
h) Upload means for accepting a plurality of playback data files from said second client computer
i) Means for programming at least one said layout area of said plurality of layout areas comprising the steps of:
i) Selecting at least one selected playback data file from said plurality of playback data files
ii) Associating said at least one layout area with said selected content file
j) Means for creating a scripted playback of said selected playback data file in said at least one layout area
k) Means for storing playback data information in said database
l) Means for specifying page layout
m) Means for creating a slot in at least one layout area, wherein said slot has specifications for time, duration, and a plurality of attributes
n) Means for associating playback data with said slot
o) Means for creating a first language instruction set representing a page
p) Means for embedding a second language instruction set for a playback device
